(19) United States
(12) Patent Application Publication
(10) Pub. No.: US 2026/0163719 A1
(43) Pub. Date: Jun. 11, 2026

(54) METHOD AND APPARATUS WITH ARTIFICIAL INTELLIGENCE BASED HOMOMORPHIC ENCRYPTION

(71) Applicant: SAMSUNG ELECTRONICS CO., LTD., Suwon-si (KR)

(72) Inventors: Maksim DERIABIN, Suwon-si (KR); Sangyun OH, Suwon-si (KR); Seung Jae CHAE, Suwon-si (KR); Hyungchul KANG, Suwon-si (KR); Sunmin KWON, Suwon-si (KR); Hyun Hoon LEE, Suwon-si (KR); Rakyong CHOI, Suwon-si (KR); Sunghui HAN, Suwon-si (KR)

(73) Assignee: SAMSUNG ELECTRONICS CO., LTD., Suwon-si (KR)

(21) Appl. No.: 19/282,484

(22) Filed: Jul. 28, 2025

(30) Foreign Application Priority Data
Dec. 5, 2024 (KR) 10-2024-0179934

(51) Int. Cl. H04L 9/06; H04L 9/00

(52) U.S. Cl. CPC H04L 9/0618; H04L 9/008

(57) ABSTRACT

A processor-implemented method including encrypting an input query of a first device to generate a ciphertext according to a homomorphic encryption scheme, transmitting the ciphertext to a second device, receiving an encrypted intermediate result from the second device, the second device receiving the ciphertext and encrypting the ciphertext as the encrypted intermediate result, decrypting the encrypted intermediate result to generate a clean intermediate result, adding noise to the clean intermediate result to generate a noise added intermediate result, transmitting the noise added intermediate result to the second device, receiving a final result from the second device, the second device receiving the noise added intermediate result to perform nonlinear processing thereon to generate the final result, and generating a final response corresponding to the input query by decoding the final result.

### CROSS-REFERENCE TO RELATED APPLICATIONS

This application claims the benefit under 35 USC § 119(a) of Korean Patent Application No. 10-2024-0179934, filed on Dec. 5, 2024, in the Korean Intellectual Property Office, the entire disclosure of which is incorporated herein by reference for all purposes.

### BACKGROUND

### 1. Field

The following description relates to a method and apparatus with artificial intelligence based on homomorphic encryption for data protection.

### 2. Description of Related Art

In modern society, safe data processing has become a core element for personal information protection and data security. Specifically, artificial intelligence (AI) and machine learning (ML) technologies are widely used across various industries. Accordingly, the demands are increasing for a method for maintaining the integrity and confidentiality of data handled by those technologies. In this kind of data processing, interactions between a client and a server are essential. In these interactions, data security may be threatened.

Conventional data protection techniques were focused on safely transmitting or storing data using an encryption method. However, the emergence of homomorphic encryption, which enables an operation to be performed on encrypted data, brings a new paradigm for data protection. Homomorphic encryption that enables an operation to be performed on encrypted data without decryption substantially reduces the risk of data leakage. Homomorphic encryption may be actively applied to fields, such as medicine, finance, or public service, with high data sensitivity.

However, homomorphic encryption has a slow operation speed because the complexity is high when operating with encrypted data. In addition, homomorphic encryption may also produce operation results having decreased accuracy due to noise that may typically occur during those operations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including encrypting an input query of a first device to generate a ciphertext according to a homomorphic encryption scheme, transmitting the ciphertext to a second device, receiving an encrypted intermediate result from the second device, the second device receiving the ciphertext and encrypting the ciphertext as the encrypted intermediate result, decrypting the encrypted intermediate result to generate a clean intermediate result, adding noise to the clean intermediate result to generate a noise added intermediate result, transmitting the noise added intermediate result to the second device, receiving a final result from the second device, the second device receiving the noise added intermediate result to perform nonlinear processing thereon to generate the final result, and generating a final response corresponding to the input query by decoding the final result.

The encrypting the input query may include inputting the final result to a noise removal model to obtain a final result with noise removed and generating the final response by decoding the final result with noise removed.

The first device may share the noise removal model with the second device.

The method may include storing added noise information.

The generating the final response may include inputting the final result and the added noise information to a noise removal model to obtain a final result with noise removed and generating the final response by decoding the final result with noise removed.

The encrypting the input query may include generating a homomorphic encryption key and parameters and generating the ciphertext based on the homomorphic encryption key and the parameters.

The generating the homomorphic encryption key and the parameters may include generating an encryption key, a decryption key, and an evaluation key.

The transmitting the ciphertext may include transmitting the evaluation key to the second device.

The adding of the noise may include adding random noise to the clean intermediate result, based on local differential privacy (LDP).

In a general aspect, here is provided a processor-implemented method including receiving an encrypted input query from a first device, generating an encrypted intermediate result by performing a first operation by a first sub-model of a divided artificial neural network according to a homomorphic encryption scheme on the encrypted input query, transmitting the encrypted intermediate result to the first device, receiving an intermediate result with noise added from the first device, performing a second operation by a second sub-model of the divided artificial neural network on the intermediate result with the noise added to generate a final result including noise, and transmitting the final result including the noise to the first device.

The method may include dividing the divided artificial neural network into the first sub-model and the second sub-model.

The dividing may include configuring the first sub-model to perform one or more linear functions including an addition operation, a multiplication operation, and a convolution operation and configuring the second sub-model to perform one or more nonlinear functions of a nonlinear activation function operation and a comparison operation, based on the homomorphic encryption scheme.

The divided artificial neural network model may be a transformer model and the method may include dividing an encoder of the transformer model into the first sub-model and dividing a decoder of the transformer model into the second sub-model.

The receiving of the encrypted input query may also include receiving an evaluation key and homomorphic encryption parameters from the first device and the generating the encrypted intermediate result may include generating the encrypted intermediate result by performing an operation of the first sub-model on the encrypted input query, based on the evaluation key and the homomorphic encryption parameters.

In a general aspect, here is provided an electronic device including processors configured to execute instructions, a memory storing the instructions, and an execution of the instructions configures the processors to encrypt an input query of a first device to generate a ciphertext according to a homomorphic encryption scheme, transmit the ciphertext to a second device, receive an encrypted intermediate result from the second device, the second device receiving the ciphertext and encrypting the ciphertext as the intermediate result, decrypt the encrypted intermediate result to generate a clean intermediate result, add noise to the clean intermediate result to generate a noise added intermediate result, transmit the noise added intermediate result to the second device, receive a final result from the second device, the second device receiving the noise added intermediate result to perform nonlinear processing thereon to generate the final result, and generate a final response corresponding to the input query by decoding the final result.

The processors may be further configured to input the final result to a noise removal model to obtain a final result with noise removed and generate the final response by decoding the final result with noise removed.

The first device may share the noise removal model with the second device.

The processors may be further configured to store added noise information, input the final result and the added noise information to a noise removal model to obtain a final result with noise removed, and generate the final response by decoding the final result with noise removed.

The processors may be further configured to generate a homomorphic encryption key and parameters and generate the ciphertext based on the homomorphic encryption key and the parameters.

The processors may be further configured to generate an encryption key, a decryption key, and an evaluation key and transmit the evaluation key to the second device.

Other features and aspects will be apparent from the following detailed description, the drawings, and the claims.

### BRIEF DESCRIPTION OF THE DRAWINGS

FIG. 1 illustrates an example homomorphic encryption system according to one or more embodiments.

FIG. 2 illustrates an example device according to one or more embodiments.

FIG. 3 illustrates an example artificial neural network model according to one or more embodiments.

FIG. 4 illustrates an example method with homomorphic encryption according to one or more embodiments.

FIG. 5 illustrates an example method with a noise removal model according to one or more embodiments.

FIG. 6 illustrates an example method with homomorphic encryption according to one or more embodiments.

FIG. 7 illustrates an example method with homomorphic encryption according to one or more embodiments.

FIG. 8 illustrates an example first device according to one or more embodiments.

FIG. 9 illustrates an example second device according to one or more embodiments.

Throughout the drawings and the detailed description, unless otherwise described or provided, the same or like drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

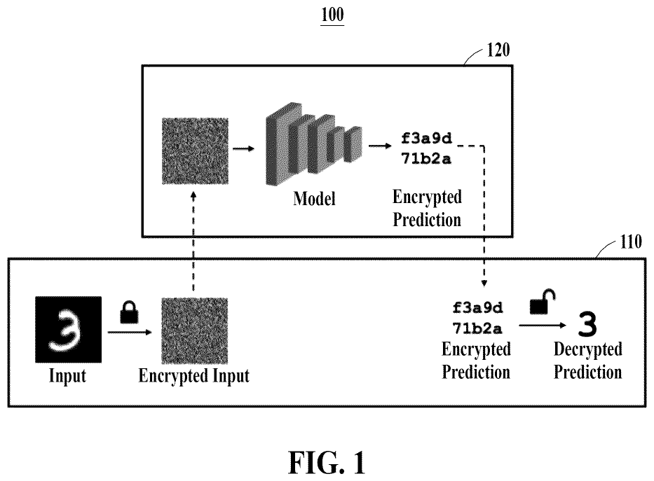

FIG. 1 illustrates an example homomorphic encryption system according to one or more embodiments.

Referring to FIG. 1, in a non-limiting example, a homomorphic encryption system 100 may include a first device 110 and a first device 110.

The homomorphic encryption system 100 may be a system in which the second device 120 provides an artificial intelligence service to the first device 110 without directly exposing data held by the first device 110 to the second device 120.

The first device 110 is a component that receives an artificial intelligence service from the second device 120 and may be referred to as a client, a service user, or a data owner. The first device 110 may encrypt its own data (e.g., a query or an image) based on a homomorphic encryption technique through a first device terminal and may transmit the encrypted data to the second device 120. The first device terminal may also be referred to as a user terminal.

Homomorphic encryption is an encryption technique for operating the encrypted data without decryption. When various operations are performed on homomorphically encrypted data, the results of these operations are the same as the results of such operations performed on unencrypted data. For example, a function evaluation without decryption may be performed on the encrypted data in fully homomorphic encryption (FHE). Homomorphic encryption may process data in its encrypted state and thus may tackle privacy concerns in the data industry. Hereinafter, encrypted data or encrypted text may be referred to as ciphertext. The ciphertext may be in the form of a polynomial or a vector including a polynomial.

The second device 120 may receive the encrypted data from the first device 110 and may transmit an artificial intelligence operation result corresponding to the encrypted data to the first device 110. The second device 120 may be referred to as a server or a service provider.

The second device 120 may provide various artificial intelligence services to the first device 110. For example, the second device 120 may provide the first device 110 with services that require the confidentiality of user data, such as natural language processing based on a language model (e.g., a large language model (LLM)), facial recognition, or mask detection. However, an operation required for providing an artificial intelligence service requires a large amount of memory and extensive network data transmission. For example, while encrypting data for convolutional neural network inference, numerous homomorphic ciphertexts are generated, which demand a large amount of memory and place an extensive burden through their resulting network data transmissions.

In an example, the homomorphic encryption system 100 may also simultaneously protect an artificial neural network model itself, the artificial neural network being owned by the second device 120, in addition to simply protecting the query of the first device 110. In this case, encrypting the data of the first device 110 through homomorphic encryption and transmitting the encrypted data to the second device 120 to perform an operation in an encrypted state may enable protection such that the query of the first device 110 may not be exposed to the second device 120.

In addition, the homomorphic encryption system, according to an embodiment, may protect the internal structure, weights, or operational details of an artificial neural network model owned by the second device 120 so that this information from the second device 120 is not exposed to the first device 110. That is, a client device such as the first device 110 may not receive information from the service provider embodied as the second device 120. This may be implemented in a method of performing a model operation in an encrypted state, adding appropriate noise to a result transmitted to the client if necessary, or providing only an encrypted result.

Specifically, to tackle privacy protection issues caused while using an LLM and a transformer-based model, in an example, the homomorphic encryption system 100 may protect the artificial neural network model itself, owned by the second device 120, in addition to the query data of the first device 110. The first device 110 may input data, such as a name, a phone number, or an email address, which contains sensitive information, and such data should not be directly exposed to the second device 120. At the same time, a model of the second device 120 is a unique asset of a server and should be protected from partial copy or theft.

As described in detail below, examples of the homomorphic encryption system 100 may protect a client query and a model itself by combining homomorphic encryption and a local differential privacy (LDP) technique and may provide security against various attacks, such as data poisoning attacks, prompt injection attacks, data extraction from the model, and disclosure of sensitive information.

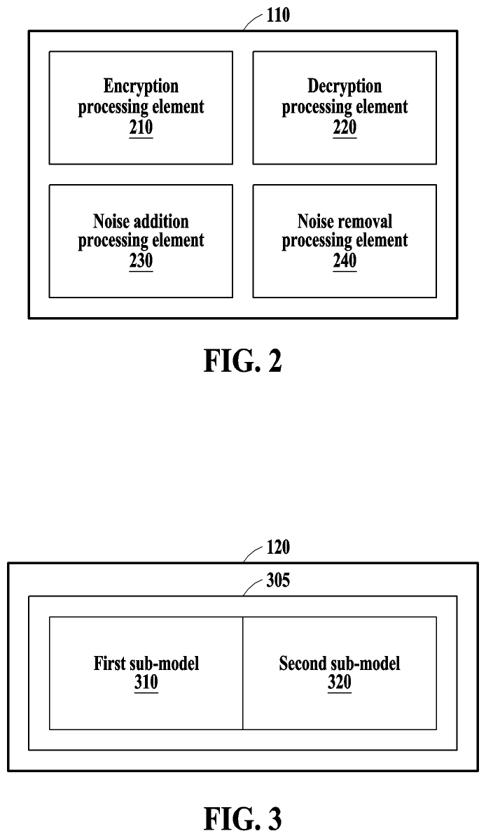

FIG. 2 illustrates an example device according to one or more embodiments. The description provided with reference to FIG. 1 may also apply to FIG. 2.

Referring to FIG. 2, in a non-limiting example, the first device 110 may include an encryption processing element 210, a decryption processing element 220, a noise addition processing element 230, and a noise removal processing element 240. However, the first device 110 may be implemented by more components than the illustrated components and the first device 110 may be implemented by fewer components.

In an example, the first device 110 may obtain input data from an artificial intelligence service. For example, the first device 110 may receive an input query for a language model service from a user of the first device 110. The first device 110 may receive a question like “What is my password?” through a prompt from the user. The first device 110 may include an input/output interface for receiving input data from the user.

The first device 110 may generate a homomorphic encryption key and parameters. For example, the first device 110 may generate the homomorphic encryption key and the parameters through a key generation unit (not shown). The homomorphic encryption key may be a key generated to perform encryption, decryption, or operations on data in quasi-homomorphic encryption. The homomorphic encryption key may include an encryption key or a public key, which is used for encryption, a decryption key or a private key, which is used for decryption, and an evaluation key, which is provided to perform operations (addition, multiplication, etc.) without the second device 120 (e.g., a server) decrypting encrypted data. The parameters are set values for determining the performance and security level of an encryption system and may affect the efficiency, accuracy, and security strength of a homomorphic encryption algorithm. The parameters may include at least one of a polynomial degree, a modulus, a noise budget, and a plaintext space, in which the polynomial degree determines the representation size of encrypted data, the modulus determines the bit size of the encrypted data, the noise budget indicates an acceptable range of noise added to the encrypted data, and the plaintext space determines a range of data values before encryption.

The first device 110 may select a homomorphic encryption system, such as Cheon-Kim-Kim-Song (CKKS), Brakerski-Fan-Vercauteren (BFV), or Fast Fully Homomorphic Encryption over the Torus (TFHE), to be used and may set the parameters, such as a polynomial degree, a decimal fraction system, a noise budget, or a plaintext space. The first device 110 may generate an encryption key, a decryption key, and an evaluation key based on the set parameters.

In an example, the encryption processing element 210 may encrypt input data to generate a ciphertext, based on parameters and an encryption key. The first device 110 may transmit the generated ciphertext to the second device 120.

After the second device 120 performs an operation on the ciphertext, the first device 110 may decrypt an encrypted result through the decryption processing element 220 and may transform it into a form that may be understood by the user. The decryption processing element 220 decrypts encrypted data by using a decryption key and may provide a response to the user's query.

As described in greater detail below, the first device 110 may add or remove noise to or from data before transmitting the data to the second device 120 or after receiving the data processed by the second device 120. The noise addition processing element 230 may increase the confidentiality of data by adding noise to intermediate data. For example, the first device 110 may add random noise based on an LDP mechanism to prevent sensitive data from being backtracked. This noise may enhance data protection level while minimizing an impact on operational accuracy. Conversely, data received from the second device 120 may be restored through the noise removal processing element 240. The noise removal processing element 240 may process data including noise based on a learned algorithm to produce more accurate results.

FIG. 3 illustrates an example artificial neural network model according to one or more embodiments. The description provided with reference to FIGS. 1 and 2 may also apply to FIG. 3.

Referring to FIG. 3, in a non-limiting example, the second device 120 may include an artificial neural network model 305 including a first sub-model 310 and a second sub-model 320. The division between sub-models (e.g., first sub-model 310 and second sub-model 320) in a neural network model (e.g., artificial neural network model 305) may enable efficient artificial intelligence operations while protecting a client's data.

In an example, the second device 120 may function as a server that receives encrypted data from the first device 110 and performs artificial intelligence operations based on the received data. Although the artificial neural network model 305 included in the second device 120 may be typically configured as a single model, in example, the typical single model may be divided into the first sub-model 310 and the second sub-model 320 of artificial neural network model 305. The division into two or more sub-models (e.g., the first sub-model 310 and the second sub-model 320) may enable efficient operations while protecting both the client's query and the server's model information.

In an example, the first sub-model 310 may be a portion of the artificial neural network model 305 that receives encrypted data from the client and performs operations in a homomorphically encrypted state. The first sub-model 310 may be designed primarily as a structure suitable for homomorphic encryption-based operations and may be configured centrally for operations (e.g., addition or multiplication) that may be performed without decrypting encrypted data. For example, in a convolutional neural network (CNN) model, a first sub-model may include relatively simple operations, such as an initial convolution layer. These operations may process encrypted data as it is and may be performed while maintaining data confidentiality.

In an example, the second sub-model 320 may be a portion of the artificial neural network model 305 that receives an intermediate result generated by the first sub-model 310 and performs the remaining complex operations in a decrypted state or a noise-added state. The second sub-model 320 may perform nonlinear operations, such as activation functions, or complex post-processing operations. For example, operations, such as Softmax, which may be operationally inefficient when processed directly based on homomorphic encryption may instead be processed in the second sub-model 320. An operational result of the second sub-model 320 is then transmitted to the first device 110, and the first device 110 may decrypt it or remove noise from it to confirm the result.

The criteria for division into these sub-models may be based on the following factors. The first criterion is operational complexity. The first sub-model 310 may be designed to be suitable for homomorphic encryption operations including relatively simple operations, while the second sub-model 320 may process more complex operations. The second criterion is the level of data protection. The first sub-model 310 may process encrypted data of the first device 110, which may ensure the data of the first device 110 is not exposed to the second device 120. The third criterion is operational efficiency. Since homomorphic encryption operations require a great deal of resources to process complex operations, simple operations may be processed in the first sub-model 310 and complex operations may be processed in the second sub-model 320 to increase operational efficiency.

For example, for an LLM used for natural language processing, the first sub-model 310 may include an initial layer (e.g., an embedding layer and some self-attention layers) that transforms input data into an embedding space. In contrast, the second sub-model 320 includes the remaining layers that understand contextual information and generate a final output (e.g., text generation). Alternatively, if the artificial neural network model 305 is a transformer-based model, the first sub-model 310 may operate as an encoder and the second sub-model 320 may operate as a decoder. This division may enable the provision of high-quality artificial intelligence services while protecting both encrypted data and model information.

In summary, the division of a neural network (e.g., artificial neural network model 305) into separate sub-models, such as the first sub-model 310 and the second sub-model 320 of FIG. 3, may protect the confidentiality of both the client's query and the server's model. This division method enables homomorphic encryption-based data processing to be in harmony with complex artificial intelligence operations and may contribute to data security between the first device 110 and the second device 120.

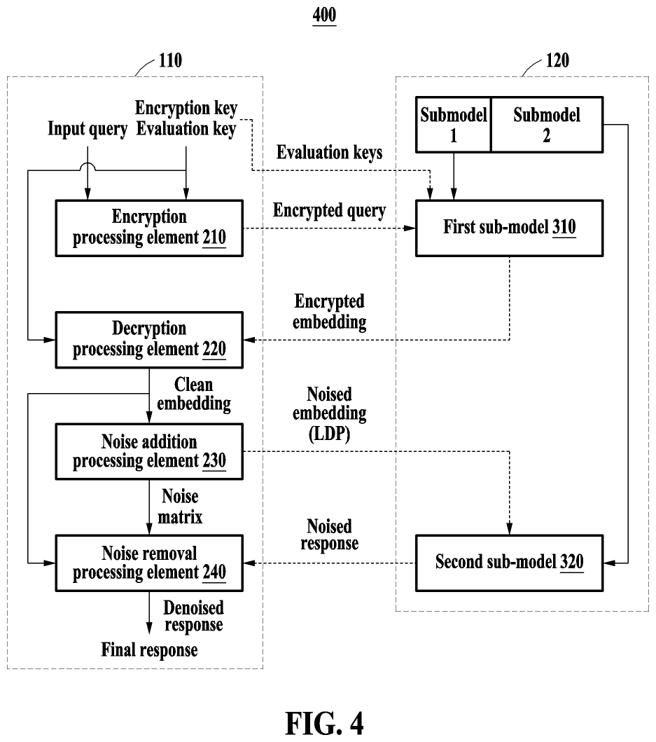

FIG. 4 illustrates an example method with homomorphic encryption according to one or more embodiments. The description provided with reference to FIGS. 1 to 3 may also apply to FIG. 4.

Referring to FIG. 4, in a non-limiting example, in method 400, the first device 110 and the second device 120 may cooperate to process an input query of the first device 110 and generate an artificial intelligence operation result. In an example, homomorphic encryption may be combined with an LDP technique to protect both the data of the first device 110 and an artificial intelligence model of the second device 120 which may enable efficient operations while maintaining data confidentiality.

In an example, a homomorphic encryption system (e.g., homomorphic encryption system 100) may divide an artificial neural network model (e.g., artificial neural network model 305) into sub-models, (e.g., the first sub-model 310 and the second sub-model 320), for its processing. A first sub-model may perform operations (e.g., addition and multiplication) that may be available for homomorphically encrypted data and a second sub-model processes the remaining operations, such as complex activation functions, to complete an inference. This divided structure enables efficient operations while protecting both client data and a server model.

More specifically, the first device 110 acts as a client and may encrypt a query input by a user through the encryption processing element 210. The encryption processing element 210 may transform the user's query into an encrypted form by using a homomorphic encryption key and an evaluation key. For example, if the user inputs a question like “What is the weather today?”, this question may be encrypted by the encryption processing element 210 and may be transformed into encrypted data in the form of a random number. This encrypted query may be transmitted to the second device 120, and during this process, the user's sensitive information will not be exposed to a server. The first device 110 transmits the evaluation key to the second device 120, which is used as a core element of homomorphic encryption-based operations. Since data cannot be decrypted by using only the evaluation key, the evaluation key may be safely shared with the second device 120. Thus, even if the evaluation key were to be exposed to an attacker, the client's original data may still be safe.

In addition, the second device 120 acts as the server and may receive an encrypted query (ciphertext) transmitted from the client. The received encrypted query may be processed in the first sub-model 310 included in the second device 120. The first sub-model 310 may perform an operation on homomorphically encrypted data in an encrypted state by using the evaluation key and may generate an operation result in the form of encrypted intermediate embedding. This intermediate embedding is returned from the second device 120 to the client, and the client may decrypt it through the decryption processing element 220 to transform it into clean embedding data. In an example, the intermediate embedding may be referred to as an intermediate result, and the clean embedding data may be referred to as a clean intermediate result.

In an example, the noise addition processing element 230 may add noise to decrypted embedding data. For example, the noise addition processing element 230 may add random noise to the decrypted embedding data according to the LDP technique. In this process, noise is added based on random values or specific probability distributions. This may prevent the client's data from being backtracked. For example, random values may be used to make subtle changes to existing data, which may enhance data confidentiality. A controlled amount of noise is added according to an LDP mechanism. This may prevent the server from backtracking decrypted data or inferring the original data of the client. The added noise may be stored in a noise matrix, and an intermediate result with the added noise may be transmitted back to the second device 120.

The second device 120 may receive data including the above described noise and may perform a final operation in the second sub-model 320. The second sub-model 320 includes complex operations, such as nonlinear activation function operations or comparison operations, and may deal with the final step of processing data on the server. For example, the second sub-model 320 may perform a final output generation process, such as a Softmax operation, in a natural language processing model. A result including noise generated in this way may be returned to the first device 110.

In an example, the first device 110 may process the returned result data through the noise removal processing element 240 to generate a final response. The noise removal processing element 240 restores data by using a pre-trained noise removal model and may provide a clear response that may be understood by the user. For example, if the client inputs a question like “What is the weather today?”, the final response to be returned may be “It's sunny today and the temperature is 25 degrees.”

However, the noise removal processing element 240 is not an essential component. If little noise is added, the first device 110 may directly decode data and generate a final response without a noise removal process. For example, if the client's operational requirements are simple or noise does not significantly affect service quality, the noise removal process may be omitted to further improve operational efficiency.

The first device 110 and the second device 120 as illustrated in FIG. 4 may enable efficient and secure artificial intelligence operations while maintaining data and model confidentiality between the first device 110 and the second device 120. This configuration may optimize the interaction between the first device 110 and the second device 120 and may minimize the possibility of data leakage by combining data protection with differential privacy protection through homomorphic encryption. In addition, the first device 110 and the second device 120 may be used in various fields of application. For example, in tasks involving sensitive data, such as medical data processing, financial data analysis, and natural language processing, the example of FIG. 4 may provide effective protection and high-accuracy services.

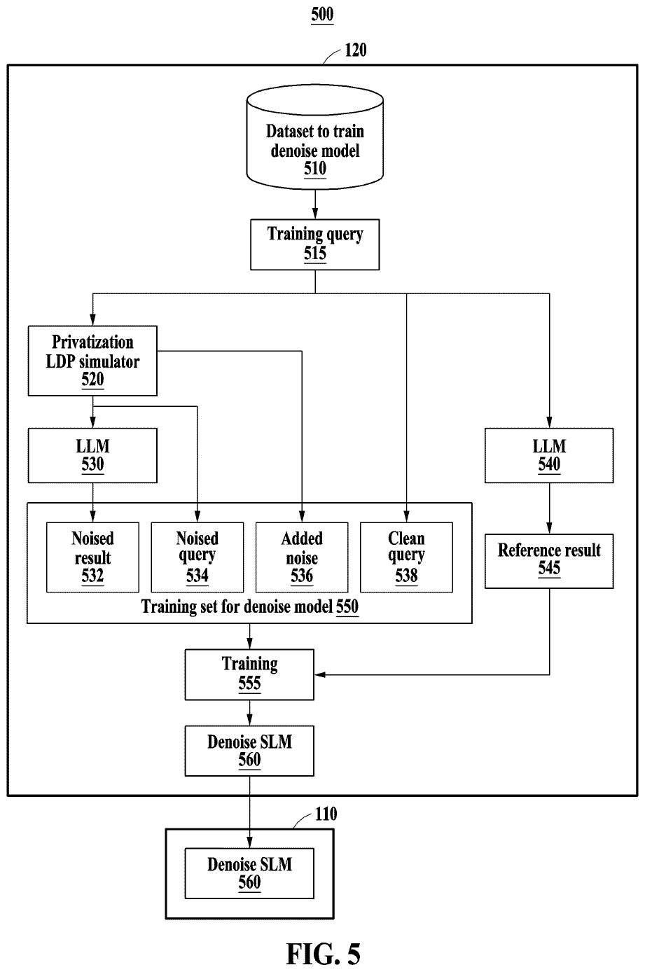

FIG. 5 illustrates an example method with a noise removal model according to one or more embodiments. The description provided with reference to FIGS. 1 to 4 may also apply to FIG. 5.

Referring to FIG. 5, in a non-limiting example, a structure 500 may share a noise removal model 560 trained in the second device 120 with the first device 110. The first device 110 and the second device 120 may cooperate to train the noise removal model 560 and, based on this, may generate high-quality results while maintaining the confidentiality of data.

In an example, the second device 120 may prepare a noise removal model training dataset 510 to train the noise removal model 560. The training dataset 510 includes various queries to be input to the first device 110 and their reference results and may provide data to be used in the training process. The training process may begin based on training query data. Training queries 515 from the training dataset 510 may be processed through an LLM 530 and a privatization LDP simulator 520. In this process, noise may be added to an input query in a manner that the first device 110 simulates data to be transmitted to the second device 120. This noise may be based on an LDP mechanism and may play a key role in protecting a client's data.

In an example, an LLM 540 may also be provided with the training queries 515 and an output of the LLM 540 be used as a reference result 545 against the training set 550 in training 555. The reference result 545 may be compared with data including noise and may be used to train the noise removal model 560 in training 555. Since it is desired for the LLM 540 to produce accurate and consistent results, the LLM 540 may be run in an optimized environment within a server to ensure the reliability of training data.

In an example, training set 550 used in the training process 555 of the noise removal model 560 may include the following data: a result including noise 532, a query including noise 534, added noise 536, a clean query 538, as well as the reference result 545. These kinds of data are generated from the LDP-based simulator 520 and the LLM 540 and may be used to optimize the performance of a noise removal model. A loss function used in the training process may be designed to minimize a difference between a result including noise and a reference result (e.g., reference result 545 from LLM 540). This may enable the noise removal model to minimize information loss caused due to noise and maximize the accuracy of results. The loss function may lead the training process to maximize a similarity between a denoise result and the reference result. This may improve the restoration performance of a model. For example, the loss function may be defined to minimize a mean squared error (MSE) between a result after denoising and the reference result or to maximize a quality metric, such as the bilingual evaluation understudy (BLEU) score, in the case of sentence generation.

After completing the training 555, the noise removal model 560 may be shared with the first device 110. The noise removal model 560 may be used to restore data including noise received by the first device 110 from the second device 120. This may enable the first device 110 to generate a final response.

In an example, the noise removal model 560 may be bypassed. For example, if there is too little noise or if the noise that is present does not have a significant impact on operation results, a client may choose to skip this process and may directly decode data. However, if the noise is large, it is likely to be desirable for the user to choose to use the noise removal model 560 as this may ensure the accuracy of a final result. The first device 110 and the second device 120 sharing the noise removal model 560 may enable the implementation of both cooperative data processing and a high security level between the client and the server.

In conclusion, the structure 500 illustrated in FIG. 5 may provide high security and accuracy by effectively combining homomorphic encryption with an LDP technique while maintaining a balance between data protection and result quality between the client and the server. Structure 500 may be used in various application fields, such as natural language processing, medical data analysis, or financial data processing.

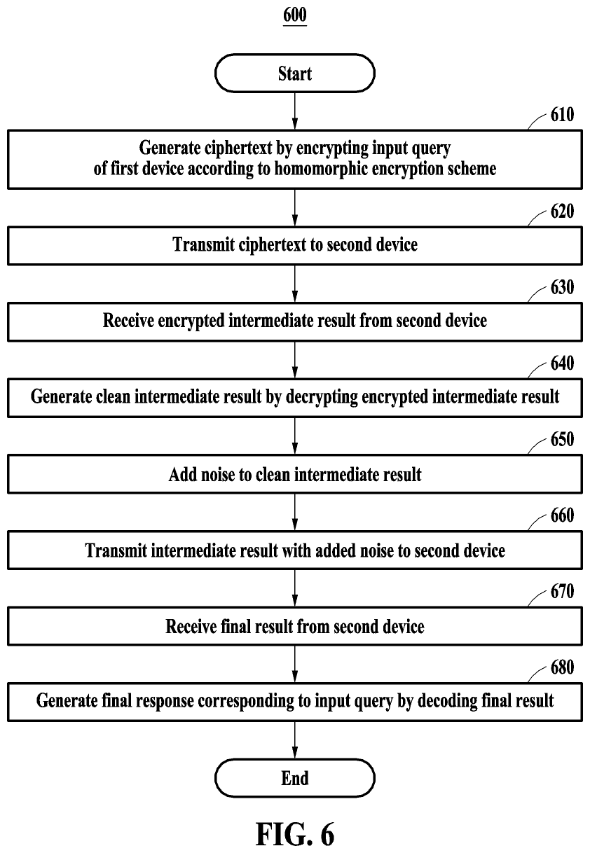

FIG. 6 illustrates an example method with homomorphic encryption according to one or more embodiments. The description provided with reference to FIGS. 1 to 5 may apply to FIG. 6 likewise.

For ease of description, it is described that operations 610 to 680 are performed by using a client device, which may be the first device 110 illustrated in FIG. 1. However, operations 610 to 680 may be performed by any suitable electronic device (e.g., an electronic device performing as a client) and in any suitable system. That is, in FIG. 6, operations 610 to 680 may be performed by an electronic device described as the client device.

Furthermore, the operations of FIG. 6 may be performed in the shown order and manner. However, the order of some operations may be changed or omitted without departing from the spirit and scope of the shown example. The operations illustrated in FIG. 6 may be performed in parallel or simultaneously.

Referring to FIG. 6, in a non-limiting example, in method 600 at operation 610, a client device (e.g., the first device 110 or an electronic device) may generate a ciphertext by encrypting an input query of the client device according to a homomorphic encryption scheme. The generation of ciphertext may protect the confidentiality of a client's data, and the client device may transform data input by a user into an encrypted form by using a homomorphic encryption key and parameters. For example, if the user inputs a query like “What is the weather today?”, this data may be transformed into a ciphertext encrypted by the encryption processing element 210.

In an example, in operation 620, the client device may transmit the ciphertext to a second device. The second device may be referred to as a server, service provider, and/or second device 120 from FIG. 1. In this process, data is exchanged between the client device and the service provider device (e.g., second device 120), and the encrypted data may be designed such that the service provider device may not directly understand the data of the electronic device.

In an example, in operation 630, the client device (e.g., first device 110) may receive an encrypted intermediate result from the service provider device (e.g., second device 120). The service provider device may return a result obtained by performing an operation through the first sub-model 310 based on the ciphertext received from the electronic device in an encrypted state.

In an example, in operation 640, the client device (e.g., first device 110) may generate a clean intermediate result by decrypting the encrypted intermediate result. A decryption process may be performed through a decryption processing element (e.g., decryption processing element 220), and the decrypted data may be designed such that sensitive parameters of a first sub-model and an input query of the client device may not be inferred.

In an example, in operation 650, the client device (e.g., first device 110) may add noise to the clean intermediate result. A noise addition processing element (e.g., noise processing element 230) may, for example, apply an LDP mechanism, which may prevent the possibility of the data of the client device being backtracked. For example, noise may be added based on random values or predefined distributions, which may enhance data confidentiality while preserving the accuracy of operation results.

In an example, in operation 660, the client device (e.g., first device 110) may transmit the intermediate result with added noise to the service provider device (e.g., second device 120). The intermediate result with added noise is not decrypted while being processed by the service provider device and thus is protected such that the original data of the client device may not be inferred.

In an example, in operation 670, the client device (e.g., first device 110) may receive a final result from the service provider device (e.g., second device 120). The final result may be a result of the service provider device completing an operation through a second sub-model (e.g., second sub-model 320) and may be returned to the client device with noise included.

In an example, in operation 680, the client device (e.g., first device 110) may generate a final response corresponding to the input query by decoding the final result. In this process, a noise removal processing element (e.g., noise removal processing element 240) may be used, and the denoise result may be restored through a pre-trained noise removal model (e.g., the pre-trained noise removal model 560).

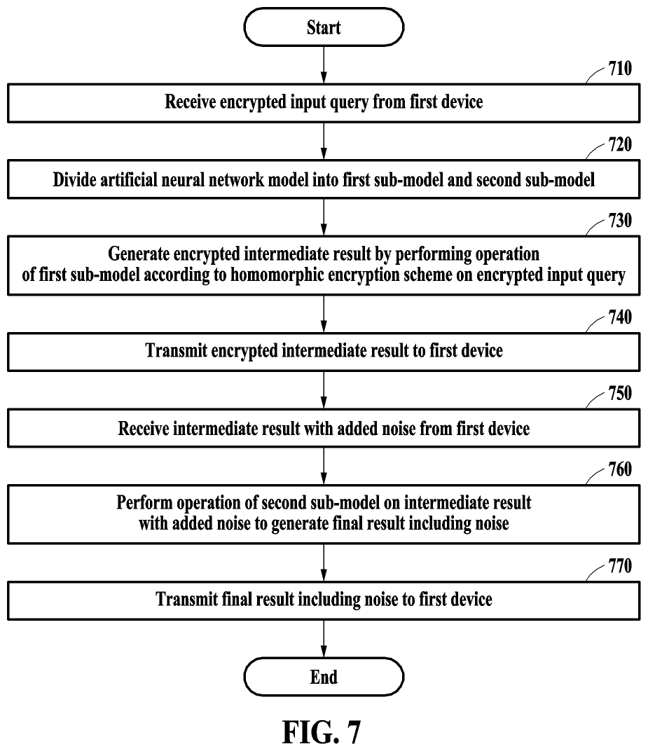

FIG. 7 illustrates an example method with homomorphic encryption according to one or more embodiments. The description provided with reference to FIGS. 1 to 6 may also apply to FIG. 7.

For ease of description, it is described that operations 710 to 770 are performed by using a server or a service provider device such as the second device 120 illustrated in FIG. 1. However, operations 710 to 770 may also be performed by another suitable electronic device in a suitable system (e.g., an electronic device performing as a server or a service provider). That is, in FIG. 7, operations 710 to 770 may be performed by an electronic device described as the service provider device.

Furthermore, the operations of FIG. 7 may be performed in the shown order and manner. However, the order of some operations may be changed, or some operations may be omitted without departing from the spirit and scope of the example shown. The operations illustrated in FIG. 7 may be performed in parallel or simultaneously.

Referring to FIG. 7, in a non-limiting example, in method 700 at operation 710, the service provider device (e.g., the second device 120) may receive an encrypted input query from the client device (e.g., the first device 110). The encrypted input query may be transmitted from the client device in an encrypted state according to a homomorphic encryption scheme, and the service provider device may process it as it is without decryption. The encrypted input query may protect the sensitive data of the client device and may not be directly understood by the service provider device.

In an example, in operation 720, the service provider device (e.g., second device 120), may divide an artificial neural network model (e.g., artificial neural network model 305) into the two or more sub-models, including a first sub-model and a second sub-model (e.g., first sub-model 310 and second sub-model 320). The division of the artificial neural network model may allow the different sub-models to perform separate operations suitable for homomorphic encryption from complex operations, such as nonlinear activation functions. For example, the first sub-model may be trained and/or configured to be suitable for processing homomorphically encrypted data. That is, the first sub-model may be configured to perform addition and multiplication operations. On the other hand, the second sub-model may be configured to perform complex nonlinear operations and may be designed to produce a final result.

In an example, in operation 730, the service provider device may generate an encrypted intermediate result by performing an operation of the first sub-model (e.g., first sub-model 310) according to a homomorphic encryption scheme on the encrypted input query. Here, an evaluation key of homomorphic encryption may be used to directly perform an operation on the encrypted data, and the data of the client device may remain protected despite the actions performed on the encrypted input query in the service provider device.

In an example, in operation 740, the service provider device (e.g., second device 120) may transmit the encrypted intermediate result to the client device (e.g., first device 110). Here, the data remains encrypted, and the service provider device cannot decrypt the intermediate result.

In an example, in operation 750, the service provider device (e.g., second device 120) may receive an intermediate result with added noise from the client device (e.g., first device 110). The client device may return the intermediate result after decrypting the intermediate result and adding noise to it to the service provider device. This noise may be a protection mechanism designed to prevent the service provider device from being able to infer the original data.

In an example, in operation 760, the service provider device (e.g., second device 120) may perform an operation of a the second sub-model (e.g., second sub-model 320) on the intermediate result with added noise to generate a final result including noise. Here, the second sub-model may processes complex operations, such as nonlinear activation functions, and the final result may be generated with noise included. In some examples, the first sub-model and the sub-model may already be divided and thus operation 760 may be skipped. That is, operation 760 may not be required for each received inquiry.

In an example, in operation 770, the service provider device (e.g., second device 120) may transmit the final result including noise to the client device (e.g., first device 110). The first device 110 may restore the received final result through a noise removal processing element (e.g., noise removal processing element 240) to generate a final response. The service provider device may complete the operation while protecting the data of the client device by transmitting only the result including noise.

For ease of description, although the example of a homomorphic encryption system according to examples herein being applied to an LLM is mainly described, examples are not limited thereto, and the homomorphic encryption system may be applied to various artificial neural network tasks. Specifically, in an example, the homomorphic encryption system may be used in the same manner in various tasks, such as image recognition, object detection, voice recognition, image analysis, medical data analysis, recommendation systems, time series data prediction, or autonomous vehicle control.

Example homomorphic encryption systems (e.g., homomorphic encryption system 100) may be applied to a CNN-based model that performs image recognition. The user may encrypt a sensitive image through homomorphic encryption in a first device (e.g., first device 110) and then transmit it to the second device (e.g., second device 120). The second device may perform some operations of a CNN in an encrypted state and may return an intermediate result to the first device. The first device may decrypt the returned data and may add noise to it and then may transmit it back to the second device to complete the remaining operations. By doing so, image classification results may be obtained without directly exposing sensitive images.

In addition, examples of the homomorphic encryption system (e.g., homomorphic encryption system 100) may be configured to handle medical data. For example, in a deep learning model that analyzes medical image data, a first device (e.g. first device 110) may encrypt a patient's sensitive medical image to transmit it to a second device (e.g., second device 120), and the second device may partially perform operations based on the encrypted data. The intermediate result may be returned to the first device in a decrypted state where noise may be added to it, and then that intermediate result with noise may be transmitted back to the second device such that a medical image analysis result may be finally derived. By doing so, high-quality analysis results may be provided while maintaining the confidentiality of sensitive medical data.

Examples of the homomorphic encryption system (e.g., homomorphic encryption system 100) may also be applied to a model for voice recognition. For example, if the user provides a voice recorded through a client device (e.g., first device 110) as an input query, the voice data may be encrypted and may be transmitted to a server device (e.g., second device 120). The server device may perform partial voice recognition operations on encrypted voice data and may return an intermediate result. The client device may decrypt the returned result, may add noise to it, and then may transmit it back to the server device to obtain a final voice-to-text conversion result.

Furthermore, examples of the homomorphic encryption system (e.g., homomorphic encryption system 100) may be used in tasks, such as time series data prediction or financial data analysis. For example, in a prediction model for financial data, sensitive financial data is processed in an encrypted state, and accurate prediction results may be generated while maintaining the confidentiality of data through the same process.

As such, examples of the homomorphic encryption system (e.g., homomorphic encryption system 100) are not limited to LLM's, and may be applied to various types of artificial neural network models and tasks, and may contribute to ensuring operational accuracy while maintaining data confidentiality. These features may greatly expand the applicability of the present invention in various industrial fields and application cases.

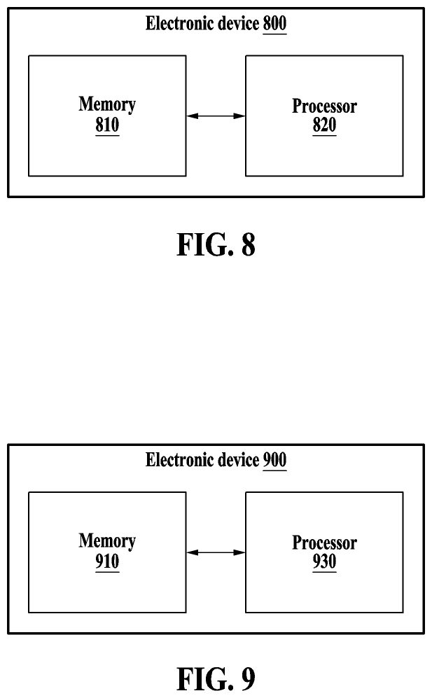

FIG. 8 illustrates an example first device according to one or more embodiments. The description provided with reference to FIGS. 1 to 7 may substantially identically apply to FIG. 8.

Referring to FIG. 8, in a non-limiting example, an electronic device 800 may include a memory 810 and a processor 820. In an example, the electronic device 800 may be the first device 110 illustrated in FIG. 1. The electronic device 800 may include, for example, various computing devices, such as a mobile phone, a smartphone, a tablet personal computer (PC), a camera device, an e-book device, a laptop, a PC, a desktop, or a workstation, various wearable devices, such as a smart watch, smart eyeglasses, a head-mounted display (HMD), or smart clothing, various home appliances such as a smart television (TV), or a smart refrigerator, and other devices, such as a smart vehicle, a smart kiosk, an Internet of things (IoT) device, a walking assist device (WAD), a drone, or a robot.

In an example, the memory 810 may include computer-readable instructions. The processor 820 may be configured to execute computer-readable instructions, such as those stored in the memory 810, and through execution of the computer-readable instructions, the processor 820 is configured to perform one or more, or any combination, of the operations and/or methods described herein. The memory 810 may be a volatile or nonvolatile memory.

The processor 820 may be configured to execute programs or applications to configure the processor 820 to control the electronic apparatus 800 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples. In an example, the processor 820 may encrypt an input query of a first device according to a homomorphic encryption scheme to generate a ciphertext, may transmit the ciphertext to a second device, may receive an encrypted intermediate result from the second device, may decrypt the encrypted intermediate result to generate a clean intermediate result, may add noise to the clean intermediate result, may transmit the intermediate result with added noise to the second device, may receive a final result from the second device, and may decode the final result to generate a final response corresponding to the input query. The processor 820 may perform operations of the first device 110 as described above with reference to FIGS. 1 to 9 in substantially the same manner. Accordingly, further description thereof is omitted herein.

FIG. 9 illustrates an example second device according to one or more embodiments. The description provided with reference to FIGS. 1 to 8 may substantially identically apply to FIG. 9.

Referring to FIG. 9, in a non-limiting example, an electronic device 900 may include a memory 910 and a processor 920. In an example, the electronic device 900 may be the second device 120 illustrated in FIG. 1. The electronic device 900 may include various server devices, such as a cloud server, an edge computing device, a data center server, a network storage server (NAS), a web server, an application server, or a database server. In addition, the second device 120 may be implemented in a rack-based server, a high-performance computing (HPC) device, a server node configured as a part of a distributed computing environment, or a virtual machine (VM) server and a container environment that operate in a private cloud or a public cloud.

In addition, the second device 120 may be implemented as a device that processes data at a network boundary, such as an edge device or an IoT hub, and may be configured as a cluster of multiple distributed servers rather than a single physical server. The second device 120 may also be implemented as a device that operates in a server farm, a data center, or a virtualization environment depending on specific application environments or service requirements.

In an example, the memory 910 may include computer-readable instructions. The processor 920 may be configured to execute computer-readable instructions, such as those stored in the memory 910, and through execution of the computer-readable instructions, the processor 920 is configured to perform one or more, or any combination, of the operations and/or methods described herein. The memory 910 may be a volatile or nonvolatile memory.

The processor 920 may be configured to execute programs or applications to configure the processor 920 to control the electronic apparatus 900 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples.

The processor 920 may receive an encrypted input query from a first device, may divide an artificial neural network model into a first sub-model and a second sub-model, may perform an operation of the first sub-model on the encrypted input query according to a homomorphic encryption scheme to generate an encrypted intermediate result, may transmit the encrypted intermediate result to the first device, may receive an intermediate result with added noise from the first device, may perform an operation of the second sub-model on the intermediate result with added noise to generate a final result including noise, and may transmit the final result including noise to the first device. The processor 920 may perform operations of the second device 120 described above with reference to FIGS. 1 to 9 in substantially the same manner. Accordingly, further description thereof is omitted herein.

The electronic devices, neural networks, models, processing elements, processors, memories, homomorphic encryption system 100, first device 110, second device 120, encryption processing element 210, decryption processing element 220, noise addition processing element 230, noise removal processing element 240, artificial neural network model 305, first sub-model 310, second sub-model 320, simulator 520, LLM 530 and 540, denoise SLM 560, first electronic device 800, memory 810, processor 820, second electronic device 900, memory 910, and processor 920 first described herein and disclosed herein described with respect to FIGS. 1-______ are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 1—that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

Volatile memory devices may be implemented as dynamic RAM (DRAM), static RAM (SRAM), thyristor RAM (T-RAM), zero capacitor RAM (Z-RAM), or twin transistor RAM (TTRAM).

Non-volatile memory devices may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
encrypting an input query of a first device to generate a ciphertext according to a homomorphic encryption scheme;
transmitting the ciphertext to a second device;
receiving an encrypted intermediate result from the second device, the second device receiving the ciphertext and encrypting the ciphertext as the encrypted intermediate result;
decrypting the encrypted intermediate result to generate a clean intermediate result;
adding noise to the clean intermediate result to generate a noise added intermediate result;
transmitting the noise added intermediate result to the second device;
receiving a final result from the second device, the second device receiving the noise added intermediate result to perform nonlinear processing thereon to generate the final result; and
generating a final response corresponding to the input query by decoding the final result.

2. The method of claim 1, wherein the encrypting the input query comprises:
inputting the final result to a noise removal model to obtain a final result with noise removed; and
generating the final response by decoding the final result with noise removed.

3. The method of claim 2, wherein the first device shares the noise removal model with the second device.

4. The method of claim 1, further comprising:
storing added noise information.

5. The method of claim 4, wherein the generating the final response comprises:
inputting the final result and the added noise information to a noise removal model to obtain a final result with noise removed; and
generating the final response by decoding the final result with noise removed.

6. The method of claim 1, wherein the encrypting the input query comprises:
generating a homomorphic encryption key and parameters; and
generating the ciphertext based on the homomorphic encryption key and the parameters.

7. The method of claim 6, wherein the generating the homomorphic encryption key and the parameters comprises:
generating an encryption key, a decryption key, and an evaluation key.

8. The method of claim 7, wherein the transmitting the ciphertext comprises:
transmitting the evaluation key to the second device.

9. The method of claim 1, wherein the adding noise comprises:
adding random noise to the clean intermediate result, based on local differential privacy (LDP).

10. A processor-implemented method, the method comprising:
receiving an encrypted input query from a first device;
generating an encrypted intermediate result by performing a first operation by a first sub-model of a divided artificial neural network according to a homomorphic encryption scheme on the encrypted input query;
transmitting the encrypted intermediate result to the first device;
receiving an intermediate result with noise added from the first device;
performing a second operation by a second sub-model of the divided artificial neural network on the intermediate result with the noise added to generate a final result including noise; and
transmitting the final result including the noise to the first device.

11. The method of claim 10, further comprising:
dividing the divided artificial neural network into the first sub-model and the second sub-model.

12. The method of claim 11, wherein the dividing comprises:
configuring the first sub-model to perform one or more linear functions including an addition operation, a multiplication operation, and a convolution operation; and
configuring the second sub-model to perform one or more nonlinear functions of a nonlinear activation function operation and a comparison operation, based on the homomorphic encryption scheme.

13. The method of claim 10, wherein the divided artificial neural network model comprises a transformer model, and
wherein the method further comprises:
dividing an encoder of the transformer model into the first sub-model; and
dividing a decoder of the transformer model into the second sub-model.

14. The method of claim 10, wherein the receiving the encrypted input query further comprises receiving an evaluation key and homomorphic encryption parameters from the first device, and
wherein the generating the encrypted intermediate result comprises:
generating the encrypted intermediate result by performing an operation of the first sub-model on the encrypted input query, based on the evaluation key and the homomorphic encryption parameters.

15. An electronic device, comprising:
processors configured to execute instructions; and
a memory storing the instructions, wherein execution of the instructions configures the processors to:
encrypt an input query of a first device to generate a ciphertext according to a homomorphic encryption scheme;
transmit the ciphertext to a second device;
receive an encrypted intermediate result from the second device, the second device receiving the ciphertext and encrypting the ciphertext as the intermediate result;
decrypt the encrypted intermediate result to generate a clean intermediate result;
add noise to the clean intermediate result to generate a noise added intermediate result;
transmit the noise added intermediate result to the second device;
receive a final result from the second device, the second device receiving the noise added intermediate result to perform nonlinear processing thereon to generate the final result; and
generate a final response corresponding to the input query by decoding the final result.

16. The electronic device of claim 15, wherein the processors are further configured to:
input the final result to a noise removal model to obtain a final result with noise removed, and
generate the final response by decoding the final result with noise removed.

17. The electronic device of claim 16, wherein the first device shares the noise removal model with the second device.

18. The electronic device of claim 15, wherein the processors are further configured to:
store added noise information;
input the final result and the added noise information to a noise removal model to obtain a final result with noise removed; and
generate the final response by decoding the final result with noise removed.

19. The electronic device of claim 15, wherein the processors are further configured to:
generate a homomorphic encryption key and parameters, and
generate the ciphertext based on the homomorphic encryption key and the parameters.

20. The electronic device of claim 19, wherein the processors are further configured to:
generate an encryption key, a decryption key, and an evaluation key, and
transmit the evaluation key to the second device.
